(19) United States
(12) Patent Application Publication
(10) Pub. No.: US 2020/0128872 A1
(43) Pub. Date: Apr. 30, 2020

(54) SMOKING WRAP ADHESIVE

(71) Applicants: Daniel Scott Hunter, East Point, GA (US); Breiana Anderson, East Point, GA (US)

(72) Inventors: Daniel Scott Hunter, East Point, GA (US); Breiana Anderson, East Point, GA (US)

(21) Appl. No.: 16/662,561

(22) Filed: Oct. 24, 2019

Related U.S. Application Data
(60) Provisional application No. 62/750,149, filed on Oct. 24, 2018.

(51) Int. Cl. A24D 1/02; A24C 5/00; A24C 1/34; C09J 193/04; C09J 105/00

(52) U.S. Cl. CPC A24D 1/025; A24D 1/022; C09J 105/00; A24C 1/34; C09J 193/04; A24C 5/005

(57) ABSTRACT

A composition for a smoking article adhesive may include, in one embodiment, the combination of pine rosin, acai gum, honey, maple syrup, an oil, and water. This composition may be applied to a smoking wrap in order to form a cigar or other smoking article containing an organic, palatable, and convenient wrap adhesive. Advantageously, such a system does not require licking the adhesive for efficacy.

### CROSS-REFERENCE TO RELATED APPLICATION(S)

The present application is related to and claims priority to U.S. Provisional Patent Application No. 62/750,149, filed Oct. 24, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of adhesives of existing art and more specifically relates to smoking articles.

### RELATED ART

In order to roll and seal tobacco, cannabis, or other products, people must lick the edge of the wrapper, leaf, or paper in order to seal it. Unfortunately, this not only spreads illness-causing germs and bacteria, but it also makes a mess and can come loose or entirely unrolled while smoking. Additionally, many tobacco roll adhesives contain non-natural ingredients that may not be optimal for human consumption. These adhesives are also not suitable for applying to custom cigars and other smokable articles by an end user. A suitable solution is desired.

U.S. Pat. No. 9,161,572 to Kesselman et al. relates to structures for creating smoking articles and methods of packaging same. The described structures for creating smoking articles and methods of packaging include methods and structures for rolling paper structures for an end user to create a cigar or cigarette. In one aspect, a rolling paper structure is provided including a first paper section having a first height, a second paper section coupled to the first paper section and the second paper section having a second height longer than the first height, and an optional adhesive disposed on the second paper section. The rolling paper structure may be folded between the first paper section and the second paper section having a portion extending beyond the first paper section. A plurality of the rolling paper structures may be disposed in a storage structure. A method for disposing rolling paper structures in and retrieving rolling papers structures from the storage structure is also provided.

### SUMMARY OF THE INVENTION

In view of the foregoing disadvantages inherent in the known smoking article art, the present disclosure provides a novel smoking wrap adhesive. The general purpose of the present disclosure, which will be described subsequently in greater detail, is to provide a smoking wrap adhesive.

A composition for a smoking article adhesive may include, in one embodiment, the combination of pine rosin, acai gum, honey, maple syrup, an oil, and water. This composition may be applied to a smoking wrap in order to form a cigar or other smoking article containing an organic, palatable, and convenient wrap adhesive. Advantageously, such a system does not require licking the adhesive for efficacy.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a smoking wrap adhesive, constructed and operative according to the teachings of the present disclosure.

FIG. 1 is a perspective view of the composition as applied to a smoking wrap during an ‘in-use’ condition, according to an embodiment of the disclosure.

FIG. 2 is a perspective view of the composition as applied to a perforated smoking wrap roll of FIG. 1, according to an embodiment of the present disclosure.

FIG. 3 is a perspective view of the composition as applied to a tubular dispenser of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a smoking article and more particularly to a smoking wrap adhesive as used to improve the assembly of a smokable article.

The smoking wrap adhesive is a useful composition safe for human consumption and useful for assembly cigars and other rolled combustible articles. The composition includes natural ingredients and may include flavor additive and other functional ingredients.

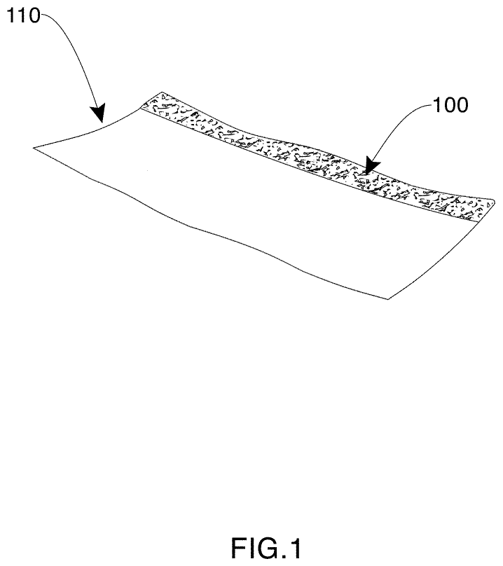

Referring now more specifically to the drawings by numerals of reference, there is shown in FIGS. 1-3, various views of a composition 100.

FIG. 1 shows a composition 100 during an ‘in-use’ condition, according to an embodiment of the present disclosure. Here, the composition may be beneficial for use by a user to adhere together a smoking wrap. As illustrated, there is also shown a wrap 110 upon which composition 100 is applied. Composition 100 may be a smoking wrap adhesive. Composition 100 may include the combination of pine rosin, acai gum, honey, maple syrup, an oil, and water. Preferably, composition 100 is the total combination of the aforementioned elements. In further embodiments, composition 100 may include one or more of the following: olive oil, CBD oil, THC extract, and beeswax.

Wrap 110 has composition 100 applied thereon. Wrap 110 may be a tobacco leaf, a paper wrap, or an organic composition paper wrap. Preferably, composition 100 is applied along a single side of wrap 120 and along a single longitudinal edge of wrap 120. Optionally, a disposable and peelable cover may be applied over the adhesive to protect the adhesive from exposure until use. During assembly of a smokable article, a user may remove the cover to expose the adhesive.

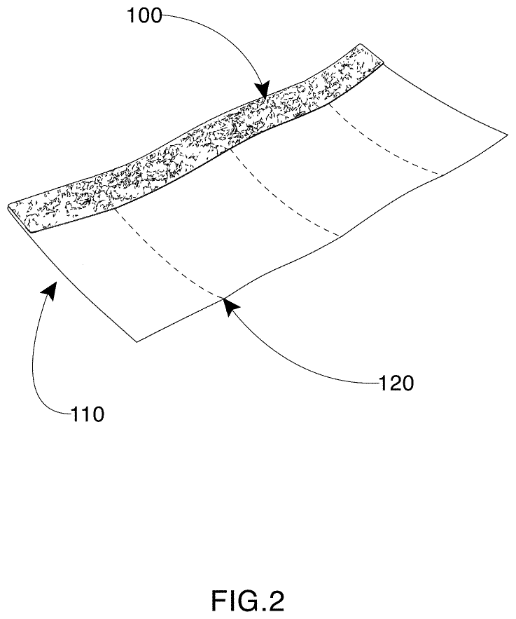

FIG. 2 shows the composition 100 and wrap 110 of FIG. 1, according to an embodiment of the present disclosure. Wrap 110 may comprise a roll having perforations 120 separating individual sheets as illustrated. In this way, a user may subdivide wrap 110 and remove only a portion for a single use, retaining multiple portions for later use in a convenient rolled package.

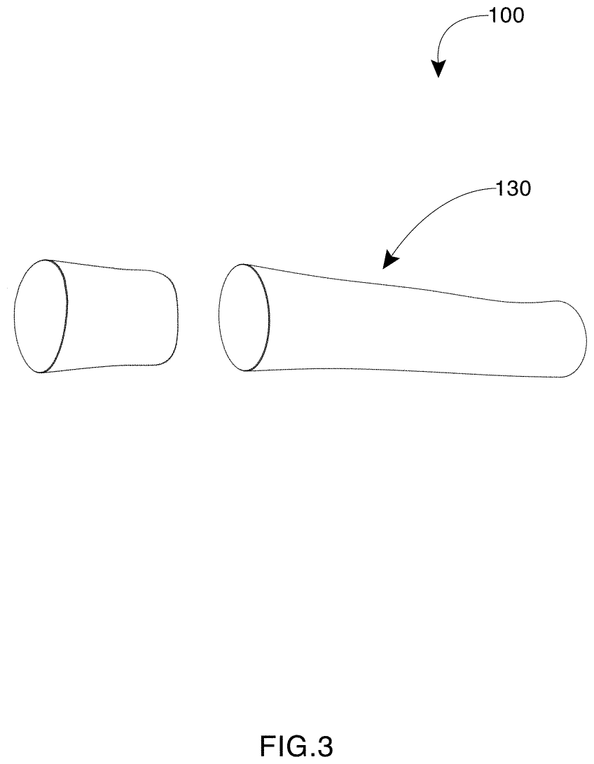

FIG. 3 is a perspective view of a tubular dispenser 130 containing the composition 100 of FIG. 1, according to an embodiment of the present disclosure. Tubular dispenser 130 may include a hollow tubular cavity and a lid which in combination may contain composition 100. Tubular dispenser 130 may be useful for applying composition 100 as desired to a smoking article.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A composition for a smoking wrap adhesive, the composition comprising:
pine rosin;
acai gum;
honey;
maple syrup;
an oil; and
water.

2. The composition of claim 1, wherein the oil comprises olive oil.

3. The composition of claim 1, further comprising CBD oil.

4. The composition of claim 1, further comprising THC extract.

5. The composition of claim 1, further comprising beeswax.

6. A wrap having the composition of claim 1 applied thereon.

7. The wrap of claim 6, wherein the wrap is a tobacco leaf.

8. The wrap of claim 6, wherein the wrap is an organic composition paper wrap.

9. The wrap of claim 8, wherein the wrap comprises a roll of perforated tear-off wrap sheets.

10. The wrap of claim 6, wherein the composition is applied only along a single side of the wrap and along a single longitudinal edge of the wrap.

11. A tubular dispenser containing the composition of claim 1.
